(19) United States
(12) Patent Application Publication
(10) Pub. No.: US 2024/0191745 A1
(43) Pub. Date: Jun. 13, 2024

(54) SHAFT

(71) Applicant: TOYOTA JIDOSHA KABUSHIKI KAISHA, Toyota-shi (JP)

(72) Inventors: Junichiro YASUI, Seto-shi (JP); Masayuki ISHIBASHI, Numazu-shi (JP); Yoshihiko UKAI, Nagoya-shi (JP)

(73) Assignee: TOYOTA JIDOSHA KABUSHIKI KAISHA, Toyota-shi (JP)

(21) Appl. No.: 18/499,497

(22) Filed: Nov. 1, 2023

(30) Foreign Application Priority Data
Dec. 12, 2022 (JP) 2022-198250

(51) Int. Cl. F16C 3/02

(52) U.S. Cl. CPC F16C 3/02; F16C 2223/06; F16C 2223/08; F16C 2226/30

(57) ABSTRACT

At a position of a depth of the first predetermined value from the surface of the gear portion, a surface treatment that satisfies a range of a required hardness defined in advance of the gear portion is performed. A surface treatment is performed at a depth of a second predetermined value from a surface of a bearing portion, the surface treatment satisfying a required hardness in a range prescribed in advance for the bearing portion. Since the second predetermined value is deeper than the first predetermined value, the hardness distribution is made different between the gear portion and the bearing portion. The required hardness in the gear portion and the required hardness in the bearing portion are respectively satisfied.

### CROSS-REFERENCE TO RELATED APPLICATION

This application claims priority to Japanese Patent Application No. 2022-198250 filed on Dec. 12, 2022, incorporated herein by reference in its entirety.

### BACKGROUND

### 1. Technical Field

The present disclosure relates to a shaft with which a gear is integrally formed.

### 2. Description of Related Art

Japanese Unexamined Patent Application Publication No. 2013-166548 (JP 2013-166548 A) discloses a structure in which a shaft that has a gear formed integrally therewith is rotatably supported by a bearing.

### SUMMARY

It is conceivable to integrate an inner race (inner ring) of a bearing with a shaft as a means for downsizing a device. When the same surface treatment (such as hardening) is performed in a configuration in which a gear portion at which a gear is formed and a bearing portion at which an inner race is formed are integrated with each other, however, the hardness distribution of the gear portion and the bearing portion is not different. It is known that the required value of the hardness in the gear portion is different from the required value of the hardness in the bearing portion. When the surface treatment is performed in accordance with the required value of the hardness of one of the gear portion and the bearing portion, the hardness of the other is not satisfied. As a result, one of the gear portion and the bearing portion may be insufficient in strength, and teeth of the gear may be damaged, the bearing may be cracked, the surface may be peeled off, or indentations may be caused.

The present disclosure has been made in view of the above circumstances. It is an object of the present disclosure to provide a shaft in which a gear portion at which a gear is formed and a bearing portion with which an inner race of a bearing is integrated each satisfy a required hardness.

The present disclosure provides
(a) a shaft with which a gear is integrally constituted, the shaft being rotatably supported by a bearing, in which:
(b) an inner race of the bearing is integrated with the shaft;
(c) a surface treatment is performed at a position at a depth of a first predetermined value from a surface of a gear portion of the shaft at which the gear is constituted, the surface treatment satisfying a required hardness in a range prescribed in advance for the gear portion;
(d) a surface treatment is performed at a position at a depth of a second predetermined value from a surface of a bearing portion of the shaft at which the inner race is constituted, the surface treatment satisfying a required hardness in a range prescribed in advance for the bearing portion; and
(e) the second predetermined value is greater than the first predetermined value.

According to the present disclosure, a surface treatment is performed at a position at a depth of a first predetermined value from a surface of a gear portion, the surface treatment satisfying a required hardness in a range prescribed in advance for the gear portion. A surface treatment is performed at a depth of a second predetermined value from a surface of a bearing portion, the surface treatment satisfying a required hardness in a range prescribed in advance for the bearing portion. Since the second predetermined value is greater than the first predetermined value, the hardness distribution is different between the gear portion and the bearing portion. As a result, the hardness required in the gear portion and the hardness required in the bearing portion can be each satisfied. As a result, it is possible to suppress cracking and surface peeling being caused in the bearing portion, and breakage of teeth and breakage of the tooth root being caused in the gear portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a shaft to which the present disclosure is applied;

FIG. 2 is a diagram showing a range of required hardness for a depth from a surface required for each gear portion and bearing portion of FIG. 1;

FIG. 3 is a view showing a structure of a shaft corresponding to another embodiment of the present disclosure;

FIG. 4 is a view showing a structure of a shaft corresponding to still another embodiment of the present disclosure; and

FIG. 5 is a diagram illustrating a configuration of a shaft according to another embodiment of the present disclosure.

### DETAILED DESCRIPTION OF EMBODIMENTS

Hereinafter, an embodiment of the present disclosure will be described in detail with reference to the drawings. Note that, in the following embodiment, the drawings are appropriately simplified or modified, and the dimensional ratios and shapes of the respective parts are not necessarily drawn accurately.

### Example 1

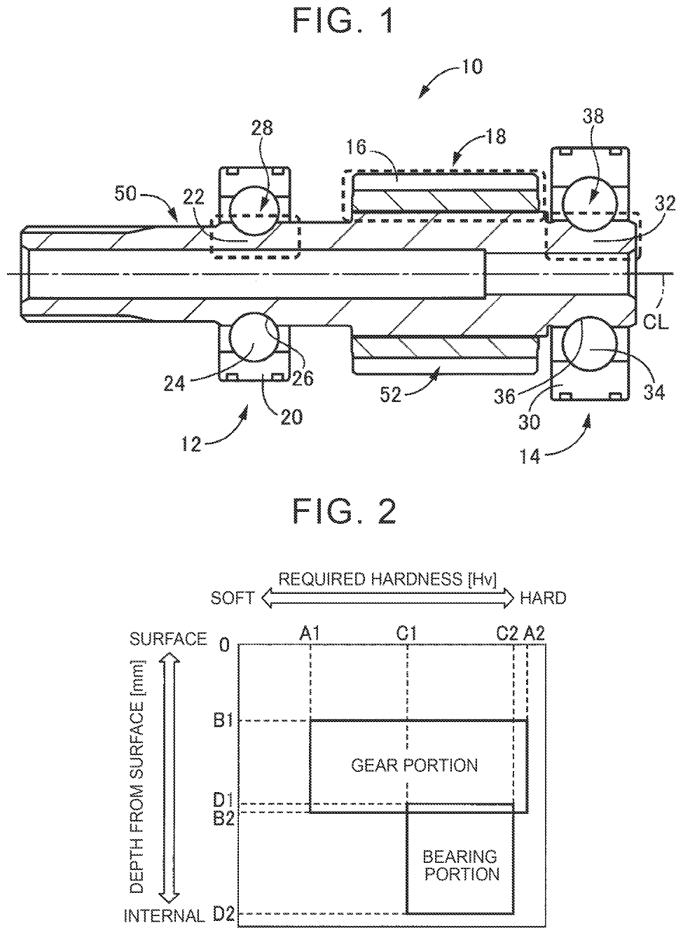

FIG. 1 is a cross-sectional view of a shaft 10 to which the present disclosure is applied. The shaft 10 is supported by the first bearing 12 and the second bearing 14 so as to be rotatable about the rotational axis CL. A rotor shaft of an electric motor (not shown), for example, is spline-fitted to an end portion of the shaft 10 closer to the first bearing 12 in the rotational axis CL.

The shaft 10 is integrally formed with a gear 16, which is an outer peripheral tooth meshing with a gear (not shown). Hereinafter, a portion surrounded by a broken line in which the gear 16 of the shaft 10 is formed is referred to as a gear portion 18.

As shown in FIG. 1, an inner race (inner ring) of each of the first bearing 12 and the second bearing 14 is integrated with the shaft 10 as a means for achieving miniaturization in a limited space.

The first bearing 12 includes an outer race 20 (outer ring), an inner race 22, and a plurality of balls 24 interposed between the outer race 20 and the inner race 22.

The outer race 20 is held by a case which is a non-rotating member (not shown). The inner race 22 is formed of a part of the shaft 10, and a recess 26 for accommodating the ball 24 is formed in an outer peripheral surface of a portion of the shaft 10 that functions as the inner race 22. A portion of the shaft 10 that functions as the inner race 22 and is surrounded by a broken line is referred to as a first bearing portion 28. The first bearing portion 28 corresponds to the bearing portion of the present disclosure.

The second bearing 14 includes an outer race 30, an inner race 32, and a plurality of balls 34 interposed between the outer race 30 and the inner race 32.

The outer race 30 is held by a case which is a non-rotating member (not shown). The inner race 32 is formed of a part of the shaft 10, and a recess 36 for accommodating the ball 34 is formed in an outer peripheral surface of a portion of the shaft 10 that functions as the inner race 32. A portion of the shaft 10 that functions as the inner race 32 and is surrounded by a broken line is referred to as a second bearing portion 38. The second bearing portion 38 corresponds to the bearing portion of the present disclosure.

Incidentally, in the gear portion 18, breakage (pitching or the like) on the tooth surface and breakage of the tooth root become a problem. On the other hand, in the first bearing portion 28 and the second bearing portion 38 (hereinafter, the bearing portion B in a case where the first bearing portion and the second bearing portion are not particularly distinguished from each other), cracks and surface peeling and indentations are problematic. As described above, since the problems occurring in the gear portion 18 and the bearing portion B are different from each other, the hardness required for each member is different accordingly. In general, in the bearing portion B, hardness is required to a region where the distance from the surface is deeper than that of the gear portion 18.

FIG. 2 shows required values (hereinafter, required hardness) of the range of hardness with respect to the depth from the surface for each of the gear portion 18 and the bearing portion B. In FIG. 2, the vertical axis indicates the depth (mm) from the surface, and the horizontal axis indicates the required hardness (Hv) with respect to the depth from the surface.

In the gear portion 18, the required hardness is defined in the range of A1 (Hv) to A2 (Hv) in the range of B1 (mm) to B2 (mm). In the gear portion 18, the required hardness is set in the range of A1 (Hv) to A2 (Hv) in a region where the depth from the front surface is B1 (mm) to B2 (mm), so that breakage of the tooth surface and breakage of the tooth root generated in the gear portion 18 are suitably suppressed. On the other hand, in the bearing portion B, the required hardness is defined in the range of C1 (Hv) to C2 (Hv) in the range of D1 (mm) to D2 (mm). In the bearing portion B, when the depth from the surface is in the range of D1 (mm) to D2 (mm), the required hardness is in the range of C1 (Hv) to C2 (Hv), cracks generated in the bearing portion B, peeling of the surface, and indentation are suitably suppressed.

As shown in FIG. 2, the position of the depth (D2 from D1) from the surface defined by the bearing portion B is at a position deeper than the position of the depth (B2 from B1) from the surface defined by the gear portion 18. That is, in the bearing portion B, the range of the required hardness is defined at a position where the depth from the surface is deeper than that of the gear portion 18. The shaft 10 is formed so as to satisfy the required hardness of the gear portion and the bearing portion shown in FIG. 2. The position of the depth from the surface of the gear portion 18 from B1 (mm) to B2 (mm) corresponds to the position of the depth of the first predetermined value from the surface of the gear portion of the present disclosure. In addition, the position of the depth from the surface of the bearing portion B from D1 (mm) to D2 (mm) corresponds to the position of the depth of the second predetermined value from the surface of the bearing portion.

Here, when the same surface treatment (such as quenching) is applied to the shaft 10, the hardness distribution does not change between the gear portion 18 and the bearing portion B, and the required hardness for the depth from the surface shown in FIG. 2 is not satisfied. For example, when hardening as a surface treatment is performed so as to satisfy the range of the required hardness with respect to the depth from the surface of the gear portion 18, the range of the required hardness with respect to the depth from the surface of the bearing portion B is not satisfied. Therefore, there is a possibility that a strength shortage occurs in the bearing portion B and a crack or the like occurs.

On the other hand, in the shaft 10, hardening is performed such that the required hardness is A1 (Hv) to A2 (Hv) at a position where the depth from the front face of the gear portion 18 is B1 (mm) to B2 (mm). In addition, hardening is performed so as to satisfy the required hardness from C1 (Hv) to C2 (Hv) at a position where the depth of the bearing portion B from the front face is D1 (mm) to D2 (mm). In order to realize this, the gear portion 18 and the bearing portion B constituting the shaft 10 are each composed of different members.

As shown in FIG. 1, the gear portion 18 and the bearing portion B of the shaft 10 are formed of different members of different materials. Specifically, the shaft 10 includes a first member 50 that is rotatably held by the first bearing 12 and the second bearing 14, and a cylindrical second member 52 that forms the gear portion 18. The first member 50 is made of, for example, a SUJ material. The second member 52 is made of, for example, a SCM material.

Prior to assembling the first member 50 and the second member 52, the first member 50 and the second member 52 are separately subjected to hardening as a surface treatment. The first member 50 is formed with a first bearing portion 28 and a second bearing portion 38. Therefore, in the first bearing portion 28 and the second bearing portion 38, hardening is performed so as to satisfy the required hardness in the bearing portion shown in FIG. 2. On the other hand, since the second member 52 constitutes the gear portion 18, hardening is performed so as to satisfy the required hardness of the gear portion shown in FIG. 2. Therefore, both the gear portion 18 and the bearing portion B satisfy the required hardness shown in FIG. 2. After the first member 50 and the second member 52 are hardened, the first member 50 and the second member 52 are integrally coupled by plastic bonding. As a result, the shaft 10 that satisfies the required hardness distribution can be obtained for each of the gear portion 18 and the bearing portion B. Since plastic bonding is a known technique, a description thereof will be omitted.

As described above, according to the present embodiment, at the position where the depth from the surface of the gear portion 18 is B1 (mm) to B2 (mm), hardening as a surface treatment is performed so that the required hardness satisfies the range of A1 (Hv) to A2 (mm). In addition, hardening is performed so as to satisfy the requirements of C1 (Hv) to C2 (mm) at a position where the depth of the bearing portion B from the front face is D1 (mm) to D2 (mm). Furthermore, the depths D1 (mm) to D2 (mm) from the surface of the bearing portion B are greater than the depths B1 (mm) to B2 (mm) from the surface of the gear portion 18. Thus, the hardness distribution is different between the gear portion 18 and the bearing portion B, and the hardness required in the gear portion 18 and the hardness required in the bearing portion B can be satisfied. As a result, it is possible to suppress cracks and peeling of the surface occurring in the bearing portion B, breakage of the tooth surface of the gear portion 18, breakage of the tooth root, and the like. The shaft 10 includes a first member 50 and a second member 52. Therefore, hardening can be performed so as to satisfy the required hardness of the gear portion 18 and the required hardness of the bearing portion B, respectively.

Next, another embodiment of the present disclosure will be described. In the following description, the same parts as those in the embodiment described above will be designated by the same reference signs and the description thereof will be omitted.

### Example 2

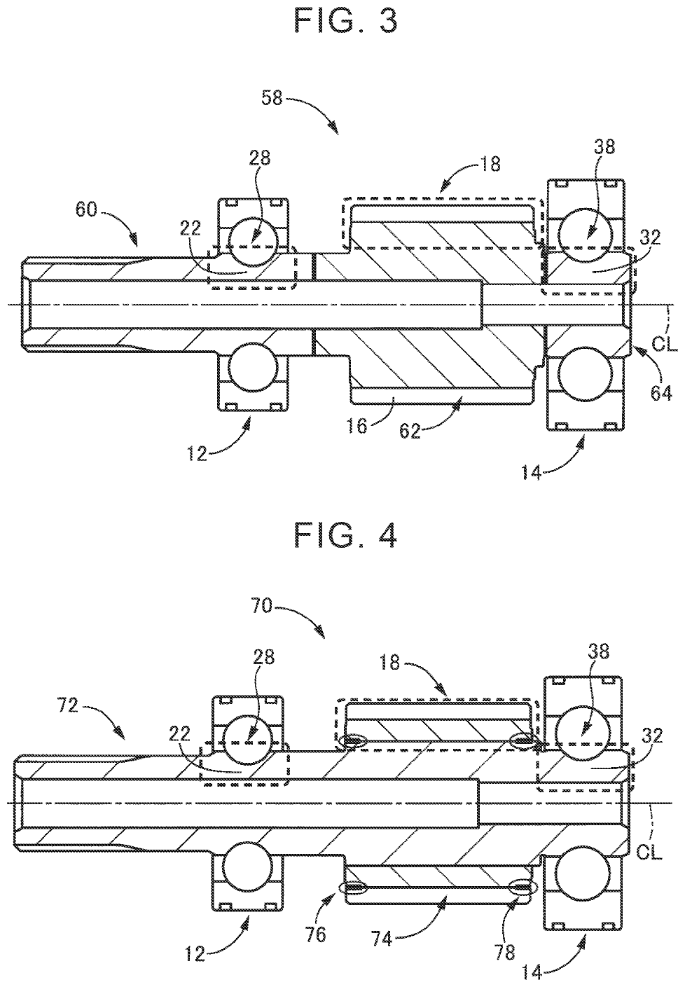

FIG. 3 is a view showing a structure of a shaft 58 corresponding to another embodiment of the present disclosure. As shown in FIG. 3, in the shaft 58, the gear portion 18 in which the gear 16 is formed, the first bearing portion 28 in which the inner race 22 of the first bearing 12 is formed, and the second bearing portion 38 in which the inner race 32 of the second bearing 14 is formed are made of different members of different materials.

Specifically, the shaft 58 includes a first member 60 on which the first bearing portion 28 is formed, a second member 62 on which the gear portion 18 is formed, and a third member 64 on which the second bearing portion 38 is formed. The first member 60 and the third member 64 are made of, for example, a SUJ material. The second member 62 is made of, for example, a SCM material. The first member 60, the second member 62, and the third member 64 are integrally coupled to each other by being friction-pressed. Since friction pressure welding is a known technique, a description thereof will be omitted.

Further, prior to assembling the first member 60, the second member 62, and the third member 64, hardening is separately performed for each of these members. The first member 60 and the third member 64 are formed with a first bearing portion 28 and a second bearing portion 38, respectively. Accordingly, the first member 60 and the third member 64 are hardened so as to satisfy the required hardness in the bearing portion shown in FIG. 2. On the other hand, since the second member 62 constitutes the gear portion 18, hardening is performed so as to satisfy the required hardness of the gear portion shown in FIG. 2. After hardening the first member 60 to the third member 64 respectively, these members are integrated by friction pressure welding. As a result, the shaft 58 satisfying the required hardness distribution can be obtained for each of the gear portion 18 and the bearing portion B.

As described above, even when the shaft 58 is composed of the first member 60, the second member 62, and the third member 64, the same effects as those of the above-described embodiment can be obtained.

### Example 3

FIG. 4 is a view showing a structure of a shaft 70 corresponding to still another embodiment of the present disclosure. As shown in FIG. 4, in the shaft 70, the gear portion 18 in which the gear 16 is formed, and the first bearing portion 28 in which the inner race 22 of the first bearing 12 is formed, and the second bearing portion 38 in which the inner race 32 of the second bearing 14 is formed are made of different members of different materials.

Specifically, the shaft 70 includes a first member 72 in which the first bearing portion 28 and the second bearing portion 38 are formed, and a cylindrical second member 74 in which the gear portion 18 is formed. The first member 72 is made of, for example, a SUJ material. The second member 74 is made of, for example, a SCM material. The first member 72 and the second member 74 are integrally coupled to each other by being caulked.

Further, prior to assembling the first member 72 and the second member 74, the first member 72 and the second member 74 are separately hardened. Specifically, in the first bearing portion 28 and the second bearing portion 38, hardening is performed so as to satisfy the required hardness in the bearing portion shown in FIG. 2. The second member 74 is hardened so as to satisfy the required hardness of the gear portion shown in FIG. 2. When the first member 72 and the second member 74 are hardened, the first member 72 and the second member 74 are caulked. Specifically, the caulking portions 76 and 78 are formed in the contact portion between the first member 72 and the second member 74 shown in FIG. 4, and the first member 72 and the second member 74 in these caulking portions 76 and 78 are integrated by being caulked. As a result, the shaft 70 satisfying the required hardness distribution can be obtained for each of the gear portion 18 and the bearing portion B.

As described above, the shaft 70 includes the first member 72 and the second member 74. Even when the first member 72 and the second member 74 are crimped and integrated, the same effects as those of the above-described embodiment can be obtained.

### Example 4

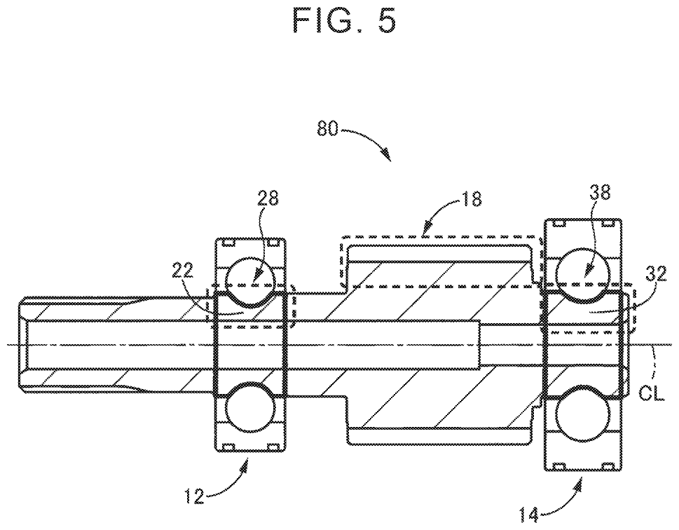

FIG. 5 shows a structure of a shaft 80 corresponding to still another embodiment of the present disclosure. In the shaft 80, the gear portion 18 and the bearing portion B are integrally formed. Further, a portion surrounded by a thick solid line corresponding to the first bearing portion 28 and the second bearing portion 38 is subjected to a burnishing process or a shot peening process, whereby a compressive residual stress is applied. Since the burnishing process and the shot peening process are known techniques, the description thereof will be omitted.

The first bearing portion 28 and the second bearing portion 38 are processed as described above. Therefore, in the first bearing portion 28 and the second bearing portion 38, the range of the required hardness of the bearing portion shown in FIG. 2 can be satisfied. The gear portion 18 is also subjected to other processing such as hardening so as to satisfy the required hardness range of the gear portion shown in FIG. 2. As a result, the shaft 80 satisfying the required hardness distribution can be obtained for each of the gear portion 18 and the bearing portion B.

As described above, even when the bearing portion B of the shaft 80 is subjected to the burnishing process or the shot peening process, the same effects as those of the above-described embodiment can be obtained.

Although the embodiments of the disclosure have been described in detail with reference to the drawings, the disclosure is also applicable to other modes.

For example, in the above-described embodiment, the first bearing portion 28 and the second bearing portion 38 are formed in the shafts 10, 58, 70, and 80. Only one of the first bearing portion 28 and the second bearing portion 38 may be formed. Specifically, one of the inner race 22 of the first bearing 12 and the inner race 32 of the second bearing 14 may be provided separately from the shaft 10.

In the above-described Examples 1 to 3, hardening is performed as the surface treatment of the gear portion 18 and the bearing portion B, respectively, but the present disclosure is not necessarily limited to the hardening. For example, as long as the surface treatment satisfies the required hardness of the gear portion 18 and the bearing portion B, such as the burnishing process or the shot peening process described in Example 4, it can be appropriately applied.

In the first and third embodiments described above, the first members 50 and 72 are made of a SUJ material, and the second members 52 and 74 are made of a SCM material. The first members 50 and 72 and the second members 52 and 74 may be made of the same material. Even when the first members 50 and 72 and the second members 52 and 74 are made of the same material, the required hardness of the gear portion 18 and the bearing portion B can be satisfied by varying the hardening conditions.

Further, in the second embodiment described above, the first member 60 and the third member 64 are made of a SUJ material, and are made of a SCM material. The first member 60, the third member 64, and the second member 62 may be made of the same material. Even when the first member 60 to the third member 64 are made of the same material, the required hardness of the gear portion 18 and the bearing portion B can be satisfied by making the hardening conditions different from each other.

In the first embodiment described above, the first member 50 and the second member 52 are integrated by plastic bonding, and in the third embodiment, the first member 72 and the second member 74 are integrated by caulking. Plastic bonding and caulking may be combined. That is, both plastic bonding and caulking may be applied.

The above description is merely an embodiment, and the disclosure can be implemented in various modified and improved modes based on the knowledge of those skilled in the art.

What is claimed is:

1. A shaft with which a gear is integrally constituted, the shaft being rotatably supported by a bearing, wherein:
an inner race of the bearing is integrated with the shaft;
a surface treatment is performed at a position at a depth of a first predetermined value from a surface of a gear portion of the shaft at which the gear is constituted, the surface treatment satisfying a required hardness in a range prescribed in advance for the gear portion;
a surface treatment is performed at a position at a depth of a second predetermined value from a surface of a bearing portion of the shaft at which the inner race is constituted, the surface treatment satisfying a required hardness in a range prescribed in advance for the bearing portion; and
the second predetermined value is greater than the first predetermined value.

2. The shaft according to claim 1, wherein:
the gear portion and the bearing portion are composed of separate members; and
the gear portion and the bearing portion are integrally coupled to each other after the gear portion and the bearing portion are hardened separately from each other.

3. The shaft according to claim 1, wherein:
the gear portion and the bearing portion are constituted integrally with each other; and
the bearing portion has been subjected to burnishing or shot peening.
